(19) United States
(12) Patent Application Publication
(10) Pub. No.: US 2015/0348588 A1
(43) Pub. Date: Dec. 3, 2015

(54) METHOD AND APPARATUS FOR VIDEO SEGMENT CROPPING

(71) Applicant: THOMSON LICENSING, Issy de Moulineaux (FR)

(72) Inventor: Neil D. VOSS, Darien, CT (US)

(21) Appl. No.: 14/471,904

(22) Filed: Aug. 28, 2014

Related U.S. Application Data
(60) Provisional application No. 62/003,281, filed on May 27, 2014.
(60) Provisional application No. 62/042,813, filed on Aug. 28, 2014.

(51) Int. Cl. G11B 27/031; G06F 3/0484; H04N 9/87; G06F 3/0488; G11B 27/00; G11B 27/10

(52) U.S. Cl. CPC G11B 27/031; G11B 27/002; G11B 27/102; H04N 9/87; G06F 3/0488; G06F 3/04845; G06F 3/04842

(57) ABSTRACT

A method and apparatus for displaying a set of video segments in an ordered list for editing is presented. The system is further operative to permit a user to edit a segment of the set of segments and play back the set of segments after editing.

### CROSS REFERENCE TO RELATED APPLICATIONS

This application claims priority from U.S. Provisional Application No. 62/003,281 filed May 27, 2014 having attorney docket number PU140089 and U.S. Provisional application No. 62/042,813 filed Aug. 28, 2014 having attorney docket number PU140124.

### FIELD

The present disclosure relates to video processing system. Specifically, the disclosure relates to a technique to edit video in segments on a media device.

### BACKGROUND

Portable electronic devices are becoming more ubiquitous. These devices, such as mobile phones, music players, cameras, tablets and the like often contain a combination of devices, thus rendering carrying multiple objects redundant. For example, current touch screen mobile phones, such as the Apple™ iPhone™ or Samsung™ Galaxy™ android phone contain video and still cameras, global positioning navigation system, internet browser, text and telephone, video and music player, and more. These devices are often enabled on multiple networks, such as WiFi™, wired, and cellular, such as 3G™, 4G™, and LTE™, to transmit and receive data.

The quality of secondary features in portable electronics has been constantly improving. For example, early “camera phones” consisted of low resolution sensors with fixed focus lenses and no flash. Today, many mobile phones include full high definition video capabilities, editing and filtering tools, as well as high definition displays. With this improved capabilities, many users are using these devices as their primary photography devices. Hence, there is a demand for even more improved performance and professional grade embedded photography tools. Additionally, users wish to share their content with others in more ways that just printed photographs. These methods of sharing may include email, text, or social media websites, such as Facebook™ Twitter™, YouTube™ and the like.

Users may wish to share and view video content easily and quickly. Today, users must upload content to a video storage site or a social media site, such as YouTube™. However, if the videos are too long, users must edit the content in a separate program prior to upload to make the video short enough for easy and quick viewing. These features are not commonly available on mobile devices, so users must first download the content to a computer to perform the editing which can include shortening a video. As this is often beyond either the skill level of the user, or requires too much time and effort to be practical, users often are dissuaded from sharing video content that the user feels is too long to be viewed easily and quickly. Thus, it is desirable to overcome these problems with current cameras and software embedded in mobile electronic devices.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

In one aspect of the invention a method of editing a video segment displayed on a media device includes receiving a plurality of video data, organizing the plurality of video data into a set of video segments, displaying the set of video segments on a touch screen of the media device, touching a first point on a selected one of the video segments with a pointing device, and dragging the pointing device to a second point in the selected video segment. The touching action on the portion of the selected video segment between the first point and the second point selects the video portion. The appearance of the selected portion of the selected video segment is changed by highlighting or graying-out the selected portion. An editing function, such as replacement, deletion, or moving of the selected portion of the selected video segment can be performed. The edited set of segments can then be played back to the user on the media device.

### BRIEF DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an exemplary embodiment of mobile electronic device;

FIG. 2 shows an exemplary mobile device display having an active display according to the present invention;

FIG. 3 shows an exemplary process for image stabilization and reframing in accordance with the present disclosure;

FIG. 4 shows an exemplary mobile device display having a capture initialization 400 according to the present invention;

FIG. 5 shows an exemplary process for initiating an image or video capture 500 in accordance with the present disclosure;

FIG. 6 shows, an exemplary embodiment of automatic video segmentation according to an aspect of the present invention;

FIG. 7 shows a method of segmenting a video 700 in accordance with the present invention;

FIG. 8 shows a light box application according to one aspect of the present invention;

FIG. 9 shows various exemplary operations that can be performed within the light box application;

FIG. 10a illustrates an editing application view of segmented video according to aspects of the invention;

FIG. 10b illustrates an editing application view showing points of editing according to an example editing embodiment;

FIG. 10c illustrates an editing application view of segments showing portions of a segment selected for editing according to an example editing embodiment;

FIG. 10d illustrates an editing application view of segments after editing according to an example editing embodiment; and

FIG. 11 illustrates an example method to edit segments according to aspects of the invention.

### DETAILED DISCUSSION OF THE EMBODIMENTS

The exemplifications set out herein illustrate preferred embodiments of the invention, and such exemplifications are not to be construed as limiting the scope of the invention in any manner.

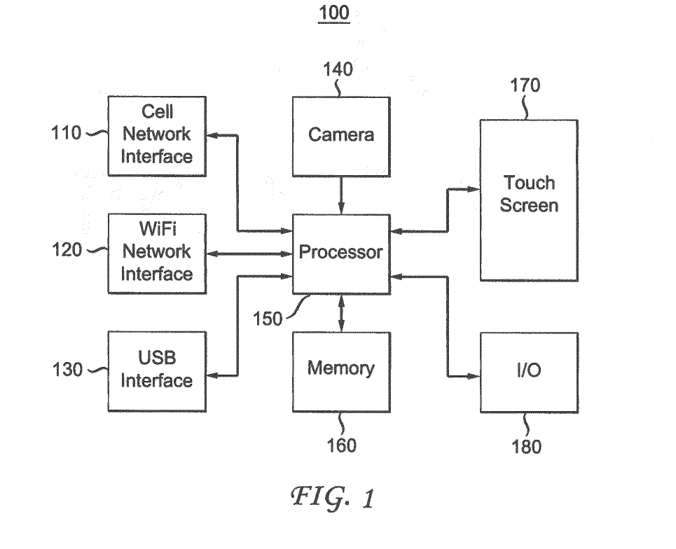

Referring to FIG. 1, a block diagram of an exemplary embodiment of mobile electronic device is shown. While the depicted mobile electronic device is a mobile phone 100, the invention may equally be implemented on any number of devices, such as music players, cameras, tablets, global positioning navigation systems, etc. A mobile phone typically includes the ability to send and receive phone calls and text messages, interface with the Internet either through the cellular network or a local wireless network, take pictures and videos, play back audio and video content, and run applications such as word processing, programs, or video games. Many mobile phones include GPS and also include a touch screen panel as part of the user interface.

The mobile phone includes a main processor 150 that is coupled to each of the other major components. The main processor, or processors, routes the information between the various components, such as the network interfaces, camera 140, touch screen 170, and other input/output I/O interfaces 180. The main processor 150 also processes audio and video content for play back either directly on the device or on an external device through the audio/video interface. The main processor 150 is operative to control the various sub devices, such as the camera 140, touch screen 170, and the USB interface 130. The main processor 150 is further operative to execute subroutines in the mobile phone used to manipulate data similar to a computer. For example, the main processor may be used to manipulate image files after a photo has been taken by the camera function 140. These manipulations may include cropping, compression, color and brightness adjustment, and the like.

The cell network interface 110 is controlled by the main processor 150 and is used to receive and transmit information over a cellular wireless network. This information may be encoded in various formats, such as time division multiple access (TDMA), code division multiple access (CDMA) or orthogonal frequency-division multiplexing (OFDM). Information is transmitted and received from the device trough a cell network interface 110. The interface may consist of multiple antennas encoders, demodulators and the like used to encode and decode information into the appropriate formats for transmission. The cell network interface 110 may be used to facilitate voice or text transmissions, or transmit and receive information from the internet. This information may include video, audio, and or images.

The wireless network interface 120, or WiFi™ network interface, is used to transmit and receive information over a WiFi™ network. This information can be encoded in various formats according to different WiFi™ standards, such as IEEE 802.11g, IEEE 802.11b, IEEE 802.11ac and the like. The interface may consist of multiple antennas encoders, demodulators and the like used to encode and decode information into the appropriate formats for transmission and decode information for demodulation. The WiFi™ network interface 120 may be used to facilitate voice or text transmissions, or transmit and receive information from the internet. This information may include video, audio, and or images.

The universal serial bus (USB) interface 130 is used to transmit and receive information over a wired link, typically to a computer or other USB enabled device. The USB interface 120 can be used to transmit and receive information, connect to the internet, transmit and receive voice and text calls. Additionally, this wired link may be used to connect the USB enabled device to another network using the mobile devices cell network interface 110 or the WiFi™ network interface 120. The USB interface 120 can be used by the main processor 150 to send and receive configuration information to a computer.

A memory 160, or storage device, may be coupled to the main processor 150. The memory 160 may be used for storing specific information related to operation of the mobile device and needed by the main processor 150. The memory 160 may be used for storing audio, video, photos, or other data stored and retrieved by a user.

The input output (I/O) interface 180 includes buttons, a speaker/microphone for use with phone calls, audio recording and playback, or voice activation control. The mobile device may include a touch screen 170 coupled to the main processor 150 through a touch screen controller. The touch screen 170 may be either a single touch or multi touch screen using one or more of a capacitive and resistive touch sensor. The mobile phone may also include additional user controls such as but not limited to an on/off button, an activation button, volume controls, ringer controls, and a multi-button keypad or keyboard.

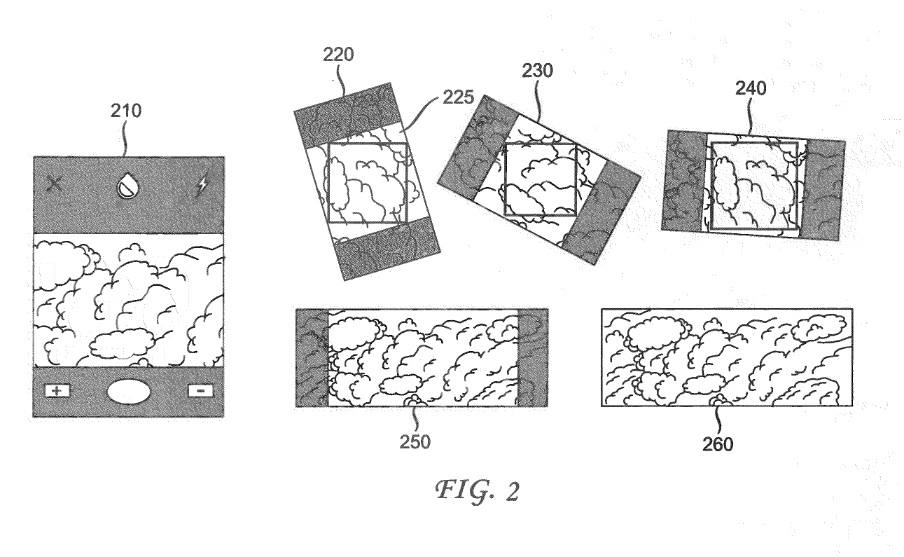

Turning now to FIG. 2 an exemplary mobile device display having an active display 200 according to the present invention is shown. The exemplary mobile device application is operative for allowing a user to record in any framing and freely rotate their device while shooting, visualizing the final output in an overlay on the device's viewfinder during shooting and ultimately correcting for their orientation in the final output.

According to the exemplary embodiment, when a user begins shooting, their current orientation is taken into account and the vector of gravity based on the device's sensors is used to register a horizon. For each possible orientation, such as portrait 210, where the device's screen and related optical sensor is taller than wide, or landscape 250, where the device's screen and related optical sensor is wider than tall, an optimal target aspect ratio is chosen. An inset rectangle 225 is inscribed within the overall sensor that is best-fit to the maximum boundaries of the sensor given the desired optimal aspect ratio for the given (current) orientation. The boundaries of the sensor are slightly padded in order to provide ‘breathing room’ for correction. This inset rectangle 225 is transformed to compensate for rotation 220, 230, 240 by essentially rotating in the inverse of the device's own rotation, which is sampled from the device's integrated gyroscope. The transformed inner rectangle 225 is inscribed optimally inside the maximum available bounds of the overall sensor minus the padding. Depending on the device's current most orientation, the dimensions of the transformed inner rectangle 225 are adjusted to interpolate between the two optimal aspect ratios, relative to the amount of rotation.

For example, if the optimal aspect ratio selected for portrait orientation was square (1:1) and the optimal aspect ratio selected for landscape orientation was wide (16:9), the inscribed rectangle would interpolate optimally between 1:1 and 16:9 as it is rotated from one orientation to another. The inscribed rectangle is sampled and then transformed to fit an optimal output dimension. For example, if the optimal output dimension is 4:3 and the sampled rectangle is 1:1, the sampled rectangle would either be aspect filled (fully filling the 1:1 area optically, cropping data as necessary) or aspect fit (fully fitting inside the 1:1 area optically, blacking out any unused area with ‘letter boxing’ or ‘pillar boxing’. In the end the result is a fixed aspect asset where the content framing adjusts based on the dynamically provided aspect ratio during correction. So for example a 16:9 video comprised of 1:1 to 16:9 content would oscillate between being optically filled 260 (during 16:9 portions) and fit with pillar boxing 250 (during 1:1 portions).

Additional refinements whereby the total aggregate of all movement is considered and weighed into the selection of optimal output aspect ratio are in place. For example, if a user records a video that is ‘mostly landscape’ with a minority of portrait content, the output format will be a landscape aspect ratio (pillar boxing the portrait segments). If a user records a video that is mostly portrait the opposite applies (the video will be portrait and fill the output optically, cropping any landscape content that falls outside the bounds of the output rectangle).

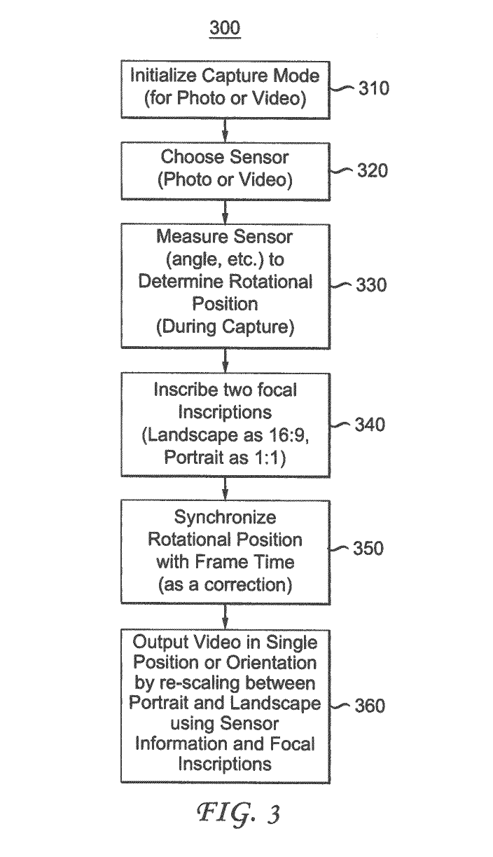

Referring now to FIG. 3, an exemplary process for image stabilization and reframing 300 in accordance with the present disclosure is shown. The system is initialized in response to the capture mode of the camera being initiated. This initialization may be initiated according to a hardware or software button, or in response to another control signal generated in response to a user action. Once the capture mode of the device is initiated, the mobile device sensor 320 is chosen in response to user selections. User selections may be made through a setting on the touch screen device, through a menu system, or in response to how the button is actuated. For example, a button that is pushed once may select a photo sensor, while a button that is held down continuously may indicate a video sensor. Additionally, holding a button for a predetermined time, such as 3 seconds, may indicate that a video has been selected and video recording on the mobile device will continue until the button is actuated a second time.

Once the appropriate capture sensor is selected, the system then requests a measurement from a rotational sensor 320. The rotational sensor may be a gyroscope, accelerometer, axis orientation sensor, light sensor or the like, which is used to determine a horizontal and/or vertical indication of the position of the mobile device. The measurement sensor may send periodic measurements to the controlling processor thereby continuously indicating the vertical and/or horizontal orientation of the mobile device. Thus, as the device is rotated, the controlling processor can continuously update the display and save the video or image in a way which has a continuous consistent horizon.

After the rotational sensor has returned an indication of the vertical and/or horizontal orientation of the mobile device, the mobile device depicts an inset rectangle on the display indicating the captured orientation of the video or image 340. As the mobile device is rotated, the system processor continuously synchronizes inset rectangle with the rotational measurement received from the rotational sensor 350. They user may optionally indicate a preferred final video or image ration, such as 1:1, 9:16, 16:9, or any ratio decided by the user. The system may also store user selections for different ratios according to orientation of the mobile device. For example, the user may indicate a 1:1 ratio for video recorded in the vertical orientation, but a 16:9 ratio for video recorded in the horizontal orientation. In this instance, the system may continuously or incrementally rescale video 360 as the mobile device is rotated. Thus a video may start out with a 1:1 orientation, but could gradually be rescaled to end in a 16:9 orientation in response to a user rotating from a vertical to horizontal orientation while filming. Optionally, a user may indicate that the beginning or ending orientation determines the final ratio of the video.

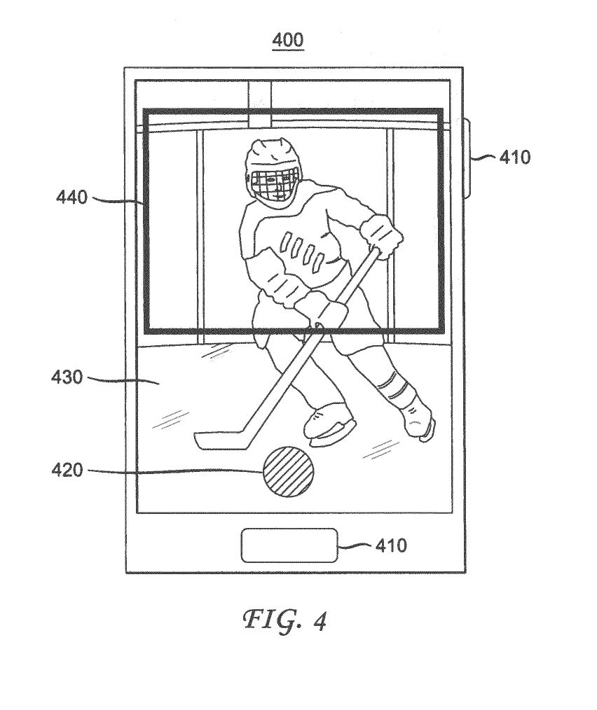

Turning now to FIG. 4, an exemplary mobile device display having a capture initialization 400 according to the present invention is shown. An exemplary mobile device is shown depicting a touch tone display for capturing images or video. According to an aspect of the present invention, the capture mode of the exemplary device may be initiated in response to a number of actions. Any of hardware buttons 410 of the mobile device may be depressed to initiate the capture sequence. Alternatively, a software button 420 may be activated through the touch screen to initiate the capture sequence. The software button 420 may be overlaid on the image 430 displayed on the touch screen. The image 430 acts as a viewfinder indicating the current image being captured by the image sensor. An inscribed rectangle 440 as described previous may also be overlaid on the image to indicate an aspect ratio of the image or video be captured.

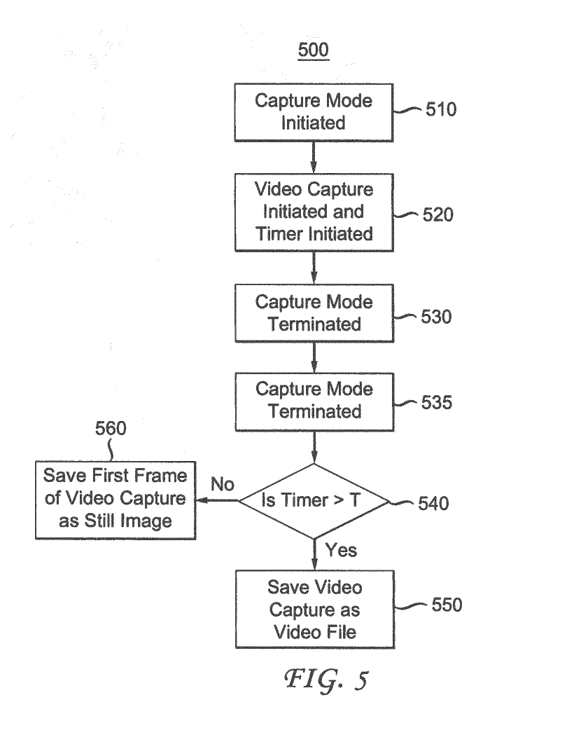

Referring now to FIG. 5, an exemplary process for initiating an image or video capture 500 in accordance with the present disclosure is shown. Once the imaging software has been initiated, the system waits for an indication to initiate image capture. Once the image capture indication has been received by the main processor 510, the device begins to save the data sent from the image sensor 520. In addition, the system initiates a timer. The system then continues to capture data from the image sensor as video data. In response to a second indication from the capture indication, indicating that capture has been ceased 530, the system stops saving data from the image sensor and stops the timer.

The system then compares the timer value to a predetermined time threshold 540. The predetermined time threshold may be a default value determined by the software provider, such as 1 second for example, or it may be a configurable setting determined by a user. If the timer value is less than the predetermined threshold 540, the system determines that a still image was desired and saves the first frame of the video capture as a still image in a still image format, such as jpeg or the like 560. The system may optionally choose another frame as the still image. If the timer value is greater than the predetermined threshold 540, the system determines that a video capture was desired. The system then saves the capture data as a video file in a video file format, such as mpeg or the like 550. The system then may then return to the initialization mode, waiting for the capture mode to be initiated again. If the mobile device is equipped with different sensors for still image capture and video capture, the system may optionally save a still image from the still image sensor and start saving capture data from the video image sensor. When the timer value is compared to the predetermined time threshold, the desired data is saved, while the unwanted data is not saved. For example, if the timer value exceeds the threshold time value, the video data is saved and the image data is discarded.

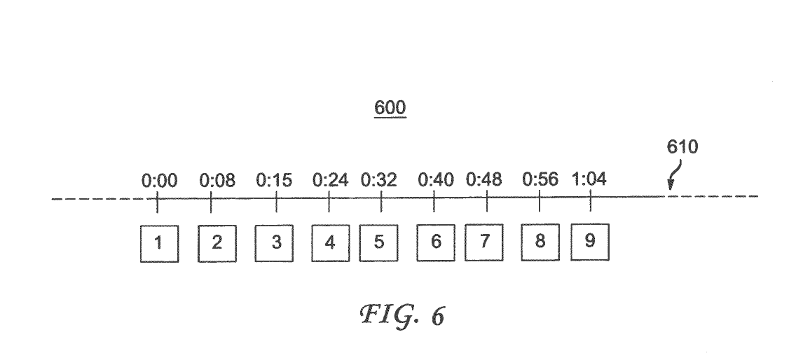

Turning now to FIG. 6, an exemplary embodiment of automatic video segmentation 600 is shown. The system is directed towards automatic video segmentation that aims to compute and output video that is sliced into segments that are as close to a predetermined time interval in seconds as possible. Additionally the segments may be longer or shorter dependant in response to attributes of the video being segmented. For example, it is not desirable to bisect content in an awkward way, such as in the middle of a spoken word. A timeline 610 is shown, depicting a video segmented into nine segments (1-9). Each of the segments is approximately 8 seconds long. The original video has a length of at least 1 minute and 4 seconds.

In this exemplary embodiment, the time interval chosen for each video segment is 8 seconds. This initial time interval may be longer or shorter, or may be optionally configurable by the user. An 8 second base timing interval was chosen as it currently represents a manageable data segment having a reasonable data transmission size for downloading over various network types. An approximately 8 second clip would have a reasonable average duration to expect an end user to peruse a single clip of video content delivered in an exploratory manner on a mobile platform. A clip of approximately 8 seconds may be a perceptually memorable duration of time where an end user can theoretically retain a better visual memory of more of the content it displays. Additionally, 8 seconds is an even phrase length of 8 beats at 120 beats per minute, the most common tempo of modern Western music. This is approximately the duration of a short phrase of 4 bars (16 beats) which is the most common phrase length (duration of time to encapsulate an entire musical theme or section). This tempo is perceptually linked to an average active heart rate, suggesting action and activity and reinforcing alertness. Furthermore, having a small, known size clip facilitates easier bandwidth calculations based upon given that video compression rates and bandwidth are generally computed around base-8 numbers, such as megabits per second, where 8 megabits=1 megabyte, therefore each segment of video would be around 1 megabyte when encoded at 1 megabits per second.

As an alternative to an 8 second segment, a 16 second segment may also be desirable. A 16 second segment can provide more content in a comfortable viewing time-frame. Although FIG. 6 depicts a timeline of 8 second time intervals, a 16 second interval is an alternative example which is equally applicable to the 8 second examples.

Turning now to FIG. 7, a method of segmenting a video 700 in accordance with the present invention is shown. In order to procedurally fragment video content into ideal segments of 8 seconds on perceptually good edit boundaries, a number of approaches to analyzing the video content may be applied within the system. First, an initial determination may made regarding the nature of the video content as to whether it originated from another application or was recorded using the current mobile device 720. If the content originated from another source or application, the video content is analyzed first for obvious edit boundaries using scene break detection 725. Any statistically significant boundaries may be marked, with emphasis on the boundaries on or nearest to the desired 8 second interval 730. If the video content was recorded using the current mobile device, the sensor data may be logged while recording 735. This may include the delta of movement of the device on all axes from the device's accelerometer and/or the rotation of the device on all axes based on the device's gyroscope. This logged data may be analyzed to find motion onsets, deltas that are statistically significant relative to the mean magnitude over time for any given vector. These deltas are logged with emphasis on the boundaries nearest to the desired 8 second interval 740.

The video content can be further perceptually analyzed for additional cues that can inform edit selection. If the device hardware, firmware or OS provides any integrated region of interest (ROI) detection, including face ROI selection, it is utilized to mark any ROIs in the scene 745. The onset appearance or disappearance of these ROIs (i.e. the moments nearest when they appear in frame and disappear from frame) can be logged with emphasis on the boundaries nearest to the desired 8 second interval.

Audio-based onset detection upon overall amplitude will look for statistically significant changes (increases or decreases) in amplitude relative to either the zero crossing, a noise floor or a running average power level 750. Statistically significant changes will be logged with emphasis on those nearest to the desired 8 second interval. Audio-based onset detection upon amplitude within spectral band ranges will rely on converting the audio signal using a FFT algorithm into a number of overlapping FFT bins. Once converted, each bin may be discreetly analyzed for statistically significant changes in amplitude relative to its own running average. All bins are in turn averaged together and the most statistically significant results across all bands are logged as onsets, with emphasis on those nearest to the desired 8 second interval. Within this method the audio can be pre-processed with comb filters to selectively emphasize/deemphasize bands, for example, the bands in the range of normal human speech can be emphasized whereas high frequency bands synonymous with noise can be deemphasized.

Visual analysis of the average motion within content can be determined for a video content to help establish an appropriate segmentation point 755. At a limited frame resolution and sampling rate as required for real time performance characteristics, the magnitude of the average motion in-frame can be determined and used to look for statistically significant changes over time, logging results with emphasis on those nearest to the desired 8 second interval. Additionally, the average color and luminance of the content can be determined using a simple, low resolution analysis of the recorded data, logging statistically significant changes with emphasis on those nearest to the desired 8 second interval.

Once any or all of the above analysis is completed, the final logged output may be analyzed weighting each result into an overall average 760. This post-processing pass of the analysis data finds the most viable points in time based on the weighted and averaged outcome of all individual analysis processes. The final, strongest average points on or nearest the desired 8 second interval are computed as output that forms the model for fragmentation edit decisions.

The post processing step 760 may consider any or all of the previously mentioned marked points on the video as indicators of preferred segmentation points. The different determination factors can be weighted. Also, determination points that vary too far from the preferred segment length, such as 8 seconds, may be weighted lower than those closest to the preferred segment length.

As indicated above with respect to FIG. 6, a 16 second time interval example for segmentation is also an option. In the 16 second instance, the same method of segmentation provided depicted in method 700 can be used. The advantage of a 16 second segment over an 8 second segment is a longer viewing time per segment to examine contents of a media recording.

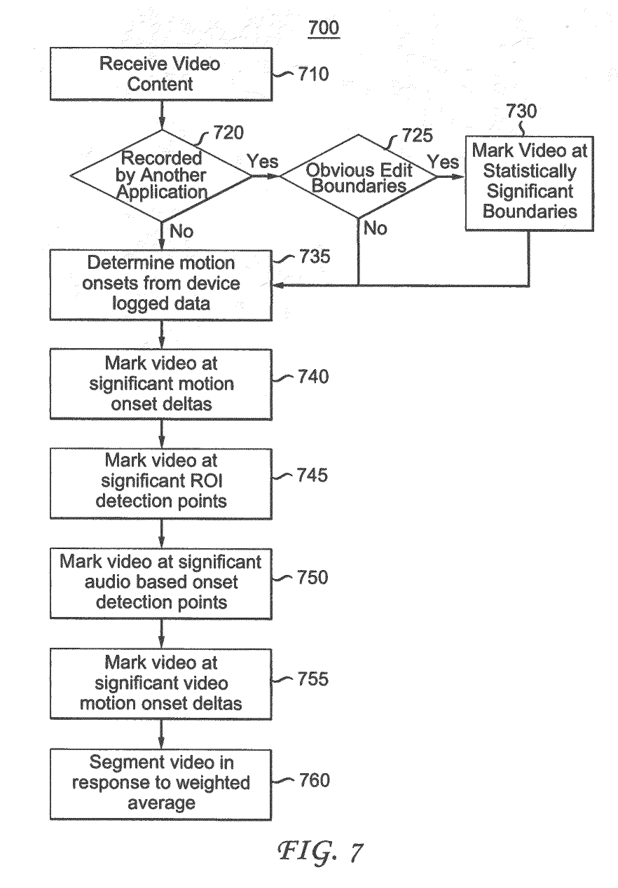

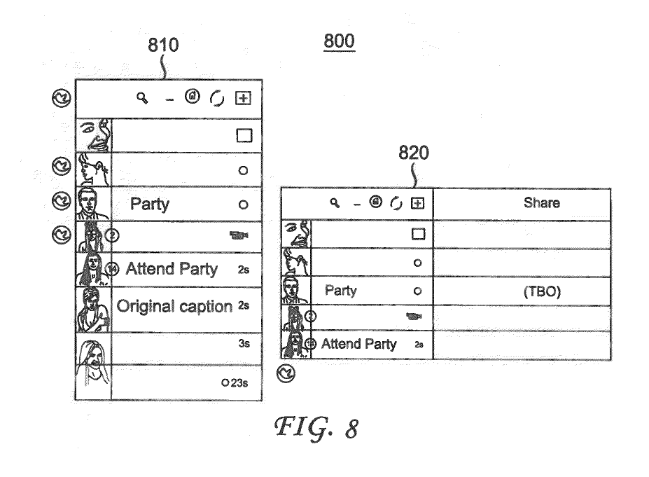

Turning now to FIG. 8, a light box application 800 according to one aspect of the present invention is shown. The light box application is directed towards a method and system for using a list-driven selection process to improve video and media time-based editing. The light box application is shown in both the vertical 810 and the horizontal orientation 820. The light box application may be initiated after a segmented video has been saved. Alternatively, the light box application may be initiated in response to a user command. Each of the segments is initially listed chronologically with a preview generated for each. The preview may be a single image taken from the video segment or a portion of the video segment. Additional media content or data can be added to the light box application. For example, photos or videos received from other sources may be included in the light box list to permit a user to share or edit the received content or combine these received contents with newly generated content. Thus, the application permits video and media time-based editing into a simple list driven selection process.

The light box application may be used as a center point for sharing editorial decisions. The light box allows users to quickly and easily view content and decide what to keep, what to discard, and how and when to share with others. The light box function may work with the camera, with channel browsing, or as a point to import media from other places. The light box view may contain a list of recent media or grouped sets of media. Each item, image or video, is displayed as at thumbnail, with a caption, a duration, and a possible group count. The caption may be generated automatically or by the user. The duration may be simplified, so as to present to the user the weight and pace of the media content. The light box title bar may include the category of the light box set with its item count, along with navigation to go back, import an item, or open a menu.

The light box landscape view 820 offers a different layout, with media items listed on one side and optionally, a method of sharing in some immediately assessable form on the other side. This may include links or previews of Facebook™, Twitter™, or other social media applications.

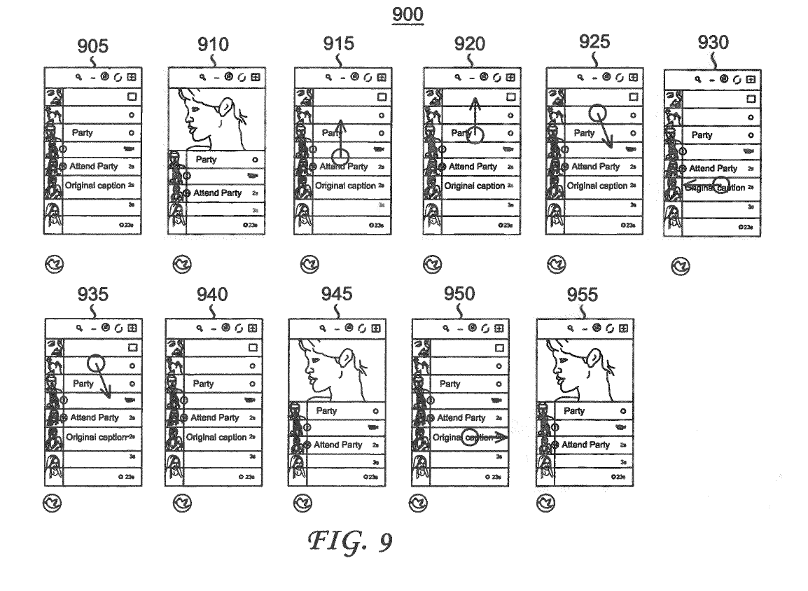

Turning now to FIG. 9, various exemplary operations 900 that can be performed within the light box application are shown. Media that is captured, by an integrated camera feature for example, imported from the device's existing media library, possibly recorded with or created by other applications or downloaded from web based sources, or curated from content published directly within the related application is all collected into the light box in a preview mode 905. The light box presents media in a simple vertical list, categorized into groups based on events, such as groupings of time, within which the media was collected. Each item is represented by a list row including a thumbnail or simplified duration for the given piece of media. By tapping on any item the media can be previewed in an expanded panel that displays in direct relation to the item.

The light box application may optionally have an expanded items view 910, which previews the item. The expanded items view 910 exposes options to processing the media item, captioning, and sharing it. Tapping the close button closes the item or tapping another item below it closes the item and opens another.

Scrolling up or down within the light box application permits the user to navigate the media items 915. The header may remain at the top of the list, or it may float atop the content. Scrolling to the end of a list may enable navigation to other, older lists 920. The headings of the older lists may be revealed under tension while dragging. Dragging past tension transitions to the older lists. Holding and dragging on an item allows the user to reorder items or combine items by dragging one onto another 925. Swiping an item to the left removes the item from the light box 930. Removing items may or may not remove them from the device, not just the light box application. Dragging and dropping items onto other items may be used to combine the items into a group 935, or combine the dragged item into a group. Pinching items together combines all items that were within the pinch range into a group 940. When previewing combined items, they play sequentially and show an item count that can be tapped to expand the combined items below the preview window 945. The regular light box items may then be pushed down to permit the expanded items to be displayed as rows.

Items can be manipulated by dragging on them from within the light box application. Items can be removed from the light box application by dragging left on any item the item for example 930. By dragging right on any item, the item can be promoted to publish immediately 950, which transitions to a screen allowing the user to share the given item's media on one or many sharing locations 955. Tapping a share button when previewing may also enable the sharing of an item. By pressing holding on any item it becomes draggable, at which point the item can be dragged up and down to re-organize its position in the overall list. Time in the list is represented vertically, top-to-bottom. For example, the top most item is first in time were the media to be performed sequentially. Any whole group of items (kept under a single event heading) can be collectively previewed (played sequentially as a single preview comprised of all items in order of time), can be collectively deleted or published using the same gestures and means of control as a single list item. When previewing any item that contains video or time-based media, playback can be controlled by dragging left-to-right on the related list item row. The current position in time is marked by a small line that can be dragged to offset time during playback by the user. When previewing any item that contains video or time-based media, by pinching with 2 fingers horizontally upon the related list item row a selection range is defined which can be pinched and dragged in order to trim the original media as the final playback output. When previewing any item that contains an image or still media, by dragging left-to-right or right-to-left on the related list item row any additional adjacent frames captured can be selectively ‘scrubbed’. For example if during a single photo capture the camera records several frames of output, this gesture can allow the user to cycle through and select the best frame as the final still frame.

Items that have recently been published (uploaded to one or many publishing destinations) are automatically cleared from the light box list. Items that time out, or live in the light box for longer than a prolonged inactivity period, such as several days, are automatically cleared from the light box list. The light box media is built upon a central, ubiquitous storage location on the device so that other applications who incorporate the same light box view all share from the same current pool of media. This makes multi-application collaboration on multimedia asset editing simple and synchronous.

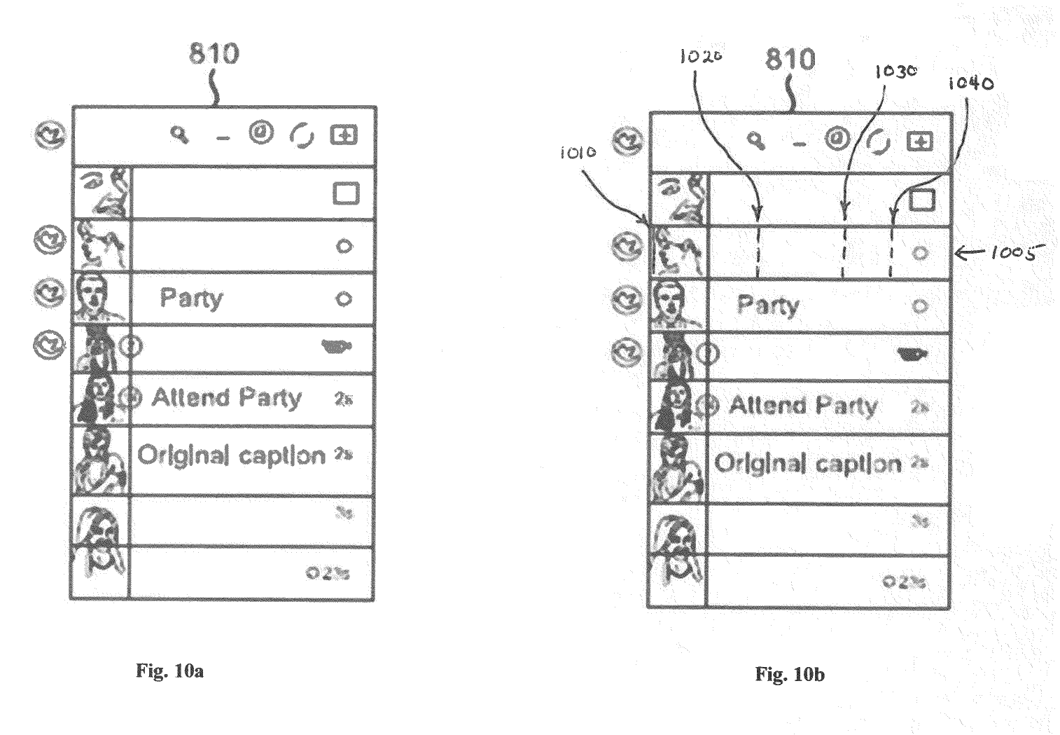

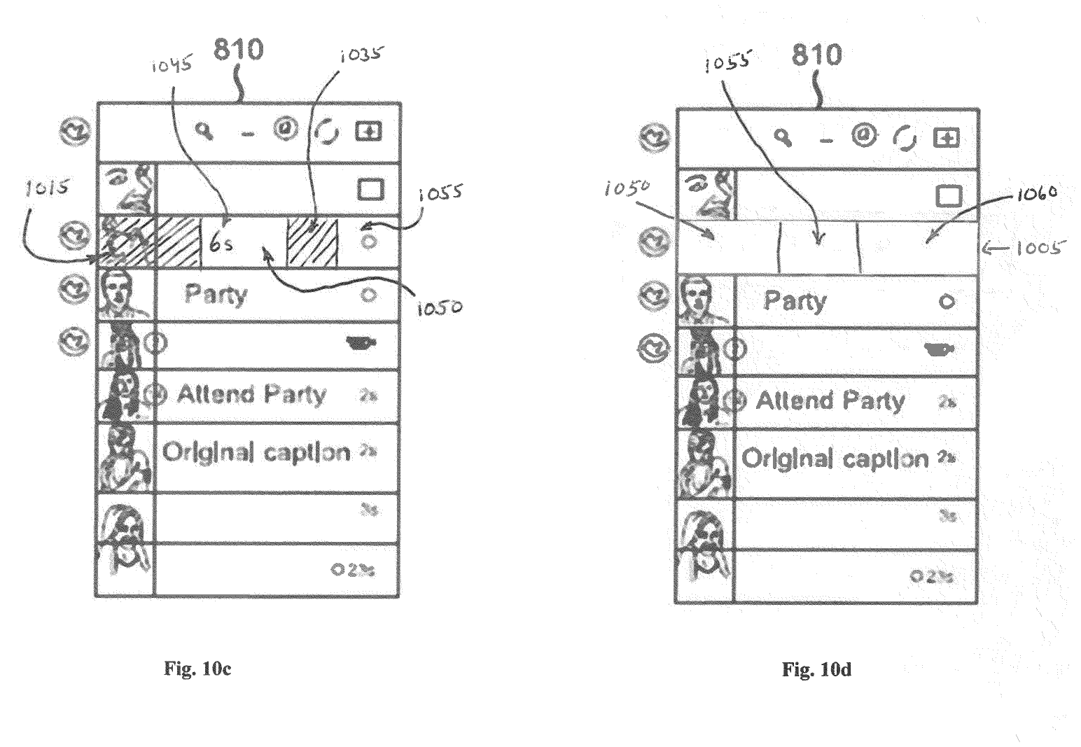

In one editing embodiment, a user interface application, such as the light box editing application, allows a user of the media device 400 to edit segments whose video was earlier captured. FIG. 10 depicts a set of segmented video recordings 810, such as the set earlier shown in FIG. 8. According to editing aspects of the invention, a user interface on the display of item 810 allows the user the opportunity to edit segments. In one example editing session, the segments are originally segmented as shown in FIG. 10a item 810. The user wishes to edit the second segment 1005. Media device 400 is used as the editing device for the segments displayed on the touch screen media device 400. Using a pointing device, such as a magnetic wand, curser, or finger to initiate an edit, a user would place their pointing device, such as finger tip on location 1010 of the display 810. This selects the beginning of the segment 1005 for editing. If the user drags their pointing device, such as a finger tip along the segment 1005 towards point 1020, and then lifts their pointing device, such as a finger off of the touch screen, the section of video between points 1010 and 1020 is selected. A pointing device can include any one of a magnetic wand, a cursor, a finger tip, or any other pointing device compatible with the touch screen of the media device.

Upon such selection, the area selected 1015 may be highlighted, bolded, grayed-out, or otherwise displayed as being selected. This selected area can then be replaced with another clip, via a user editing control, not shown, if a substitution is readily available. Alternately, the selected area 1015 could be deleted by dragging the selected clip off of the segment 810 either left or right. Alternatively, the selected area could be moved to a different area, such as a different segment and a re-segmentation initiated. However, if an additional area were desired to be selected in addition to area 1015, then the user could swipe their finger from time point location 1030 to time point location 1040 and then lift their finger. As a result, video are 1035 would also be selected in addition to area 1015. AS a result of selecting either or both of the areas 1015 or 1035, editing of the areas can be performed. As described before, editing may include such actions as replacing a selected video area, deleting a selected video area, moving a video area, and then re-segmenting.

In one aspect, during the process of selecting an image of progress, such as a time indicator 1045 as shown in FIG. 10c may be displayed to indicate to the user how far the edit has progressed in the video segment. Item 1045 indicates that the edit has progressed 6 seconds into the video segment 1005. Item 1045 can indicate elapsed time, original record time, time depth into the segment 1045, or any other convenient indication useful to the user.

FIG. 10d depicts an edited segment view 810a on the touch screen display of media device 400 after a deletion action of selected areas 1015 and 1035. What are left are unedited video subjections 1050 and 1055. In the embodiment of editing shown in FIG. 10d, the remaining video clips 1050 and 1055 were moved to occupy the beginning of segment 1005. This leaves an area for a video clip 1060 that can be filled with an insertion from the user. Alternately, not shown, the segments of view 810 can be re-segmented so that area 1060 can be filled in with segment sections remaining from the view 810.

In one embodiment, the cropped portions 1015 and 1035 are simply removed from the video segments of view 810 such that when played back, the cropped portions of the segments are not played. The above example of FIG. 10a through 10d gives one example of a user interface editing application. Any of the filtering and video effects elements described earlier can be applied to the edited segments 810a. Using the editing techniques, segments may be cropped and combined or split to add additional effects. Edited segments may be saved and shared using their cropped lengths, and combined with other segments as desired.

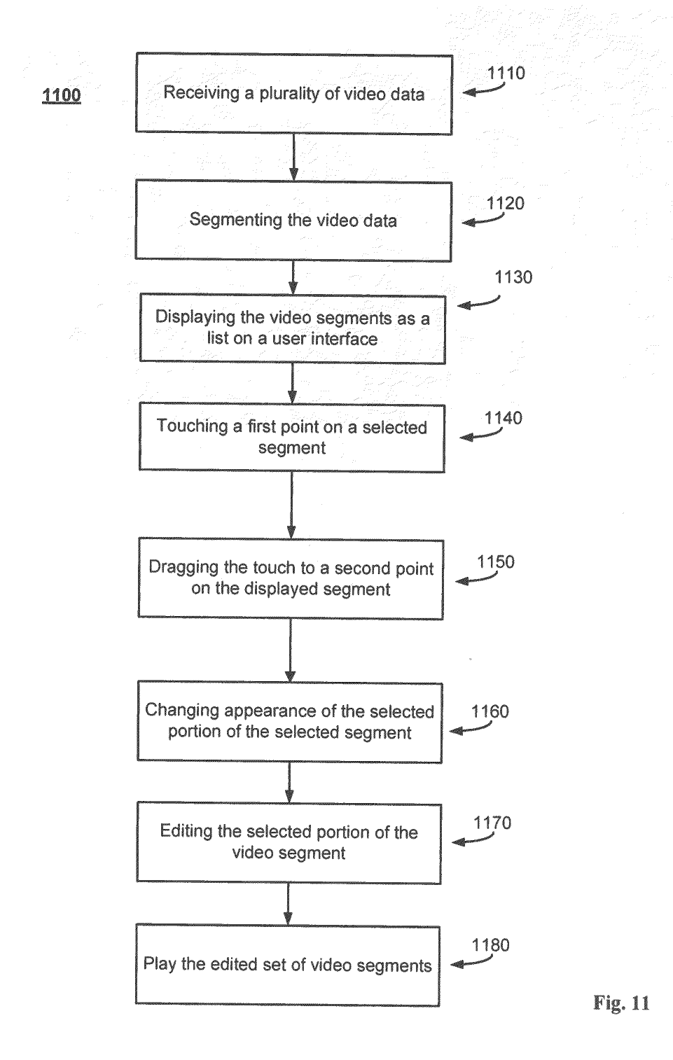

FIG. 11 depicts an example method 1100 according to aspects of the invention. At step 1110, a plurality of video data is received. Reception can involve a capture of video data with a media device, such as device 400. Alternately, if the video data is already captured and placed into memory, then reception involves accessing memory of the media device 400 to receive the plurality of video data. The raw video data that is received in step 1110 is segmented in step 1120. Segmentation is a partitioning of the raw video data into fixed time segments. In one embodiment, the fixed time segments are 8 seconds in duration. In another embodiment, the fixed time segments are 16 seconds in duration. Segmentation can involve a reduction of the raw video content or an expansion of the raw video content according to the principles of segmentation as discussed above herein.

After segmentation, the segments are displayed as a list on a user interface. One example is shown in FIG. 10a. Here, the segmented video is shown in a stack of fixed length segments. Each of the fixed length segments can be played. The display of FIG. 10a may be provided on a touch screen device such as that of media device 400 wherein a user interface is present. This user interface is useful for such actions as editing the segments or playing the segments, all or in part.

Editing the list of segments, such as shown in FIG. 10a, begins at step 1140. The touch screen of media device 400 is used as an edit interface. In one embodiment, a touch, such as a touch from a magnetic stylus, cursor, or finger, is used to determine a first point at which a video edit may begin on a selected segment. At step 1150, if the touching is dragged, that is the touch is not released from the surface of the touch screen, then a portion of the video segment can be selected. In the touch and drag embodiment, the touch initialized at step 1140 is continued to a second point on the displayed segment and a portion of the video segment is selected. At step 1160 the appearance of the selected portion of the video is given a changed appearance. This changed appearance may be a highlighting, a boldening, a graying-out, or other visual cue to distinguish the selected video portion that was selected from the rest of the segment.

At step 1170, the selected portion of the video segment is edited. Editing may be a substitution of the selected portion with a video clip from a file or other location including another segment. The edit may be a deletion of the selected portion of video in the segment. The edit may be a move of the selected portion to some other segment. Regardless of the type of edit, the edited segment or the set of segments can then be played at step 1180. Playing the edited segment or set of segments allows the user to view the results of the edits. As a result of the playback, the user may choose to edit the same or another segment, thus repeating method steps 1140 to 1180 as part of an edit and review process according to aspects of the invention.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus or a hardware and software apparatus. An apparatus may be implemented in, for example, appropriate hardware, software, and firmware. The methods may be implemented in an apparatus such as, for example, a processor, which refers to any processing device, including, for example, a computer, a microprocessor, an integrated circuit, or a programmable logic device.

Additionally, the methods may be implemented by instructions being performed by a processor, and such instructions may be stored on a processor or computer-readable media such as, for example, an integrated circuit, a software carrier or other storage device such as, for example, a hard disk, a compact diskette (“CD” or “DVD”), a random access memory (“RAM”), a read-only memory (“ROM”) or any other magnetic, optical, or solid state media. The instructions may form an application program tangibly embodied on a computer-readable medium such as any of the media listed above or known to those of skill in the art. Such instructions, when executed by a processor, allow an apparatus to perform the actions indicated by the methods described herein.

1. A method of editing a video segment displayed on a media device, the method comprising:
receiving a plurality of video data;
organizing the plurality of video data into a set of video segments;
displaying the set of video segments on a touch screen of the media device;
touching a first point on a selected one of the video segments with a pointing device;
dragging the pointing device to a second point in the selected video segment, wherein a portion of the selected video segment between the first point and the second point is selected;
changing an appearance of the selected portion of the selected video segment;
performing an editing function upon the selected portion of the selected video segment;
playing the set of video segments including the edited selected segment using the media device.

2. The method of claim 1, wherein receiving a plurality of video data comprises reading the plurality of media data from a memory of the media device.

3. The method of claim 1, wherein organizing the plurality of video data into a set of video segments comprises separating the plurality of video data into fixed time segments of video data.

4. The method of claim 3, wherein the fixed time segments are 16 second segments.

5. The method of claim 1, wherein displaying the set of video segments on a touch screen of the media device comprises displaying a chronological list of the set of video segments.

6. The method of claim 1, wherein touching a first point on a selected one of the video segments with a pointing device comprises touching using one of a magnetic stylus, a cursor, or a finger.

7. The method of claim 1, wherein changing an appearance of the selected portion of the selected video segment comprises one of highlighting, bolding, or graying-out the selected portion;
performing an editing function upon the selected portion of the selected video segment;
playing the set of video segments including the edited selected segment using the media device.

8. The method of claim 1, wherein performing an editing function upon the selected portion of the selected video segment comprises one or more of replacing the selected portion, deleting the selected portion, or moving the selected portion.

9. An apparatus for editing a video segment displayed on a media device, the apparatus comprising:
a memory storing a plurality of video data;
a processor, in communication with the memory, that executes instructions that organize the plurality of video data into a set of video segments;
a touch screen for displaying the set of video segments, wherein the processor acts with the touch screen to enable selecting a portion of a selected one of the video segments with a pointing device;
wherein the processor further acts to perform an editing function of the selected portion of the selected video segment, and wherein the results of the editing function are displayed on the touch screen.

10. The apparatus of claim 9, wherein the processor enables a user to perform one or more edits of the selected video segment using the touch screen.

11. The apparatus of claim 10, wherein the one or more edits comprise a replacement of the selected portion of the selected video segment, a deletion of the selected portion of the selected video segment, or a move of the selected portion of the selected video segment.

12. The apparatus of claim 9, wherein the processor further changes the appearance of the selected portion of the selected video segment.

13. The apparatus of claim 12, wherein the change of appearance is one of a highlighting, a bolding, or a graying of the selected portion.

14. The apparatus so claim 9, wherein the processor further acts to play the set of video segments after an edit of the selected portion of the selected one of the video segments.
